(19) United States
(12) Patent Application Publication
(10) Pub. No.: US 2006/0262820 A1
(43) Pub. Date: Nov. 23, 2006

(54) Semiconductor laser device and optical pickup apparatus having the device

(75) Inventors: Takashi Itoh, Mihara-shi (JP); Takaaki Nakahashi, Mihara-shi (JP); Terukazu Takagi, Onomichi-shi (JP)

Correspondence Address: MORRISON & FOERSTER LLP, 1650 TYSONS BOULEVARD, SUITE 300, MCLEAN, VA, 22102, US

(73) Assignee: SHARP KABUSHIKI KAISHA, Osaka-shi (JP)

(21) Appl. No.: 11/430,023

(22) Filed: May 9, 2006

(30) Foreign Application Priority Data
May 18, 2005 (JP) 2005-145468

(51) Int. Cl. H01S 3/04

(52) U.S. Cl. 372/34; 372/36

(57) ABSTRACT

A semiconductor laser device has a semiconductor laser element, a starting mirror and a signal photodetector mounted on a surface of laminate ceramic package which is formed by layering a plurality of ceramic sheets having mutually different conductive patterns. The semiconductor laser device and an optical pickup apparatus having the device allow to eliminate the restrictions on arrangement of wire-bonded electrodes and wiring layout and to reduce the adverse effect of heat generated in the photodetector on the semiconductor laser element.

### CROSS-REFERENCE TO RELATED APPLICATIONS

This nonprovisional application claims priority under 35 U.S.C. §119(a) on Patent Application No. 2005-145468 filed in Japan on 18 May 2005, the entire contents of which are incorporated herein by reference.

### BACKGROUND OF THE INVENTION

The present invention relates to a semiconductor laser device for use in reading information of optical recording media and writing information into optical recording media such as CD (Compact Disc), CD-R (Compact Disc Recordable), DVD (Digital Versatile Disc) and DVD-R (Digital Versatile Disc Recordable). The present invention also relates to an optical pickup apparatus provided with the semiconductor laser device.

In accordance with the trend of reducing the size and thickness of semiconductor laser devices, development of less expensive semiconductor laser devices has been demanded. Conventionally, there has been the semiconductor laser device disclosed in JP 06-203403 A.

FIG. 5A shows a schematic top view of the conventional semiconductor laser device. FIG. 5B shows a schematic sectional view of the conventional semiconductor laser device.

As shown in FIGS. 5A and 5B, the semiconductor laser device has a lead frame 52 constructed of a die pad portion 59 and a lead terminal portion 60, and a resin package 53 resin-molded to the lead frame 52.

A semiconductor laser element 57 is mounted on a silicon substrate 58 which is die-bonded to a die pad portion 59 of the lead frame 52. A photodetection portion 56 is formed on the silicon substrate 58. Specifically, on a surface of the silicon substrate 58 which is located on the side of the semiconductor laser element 57, the photodetection portion 56 is formed for receiving light reflected on an optical disk. A pad is also formed there for electrically connecting the photodetection portion 56 and the semiconductor laser element 57 to the lead terminal portion 60.

The lead terminal portion 60 of the lead frame 52 is electrically connected to the semiconductor laser element 57 and the signal photodetector 56 via thin metal wires 51 and pads.

After carrying out burn-in and characteristic inspection, a hologram element 54 is fixed to the resin package 53 with use of a UV (ultraviolet) resin 55. Minute corrugations are formed on the surface of the hologram element 54.

According to the semiconductor laser device thus constructed, laser light emitted from the semiconductor laser element 57 is reflected on a mirror and directed toward the optical disk. The laser light is reflected on the optical disk to become optical signals which contain various pieces of information written in the optical disk, and diffracted by the hologram element 54 to be directed toward the signal photodetector 56. The optical signal is converted into an electrical signal by the signal photodetector 56, and the electrical signal is outputted to the outside via the thin metal wires 51.

In the conventional semiconductor laser device, however, the thin metal wires 51 are allowed to be led only two-dimensionally. Accordingly, there are restrictions on the arrangement of the pads or electrodes for wire-bonding the thin metal wires 51 and on the wiring layout of the thin metal wires 51.

Moreover, heat generated in the photodetection portion 56 adversely affects the semiconductor laser element 57 because the semiconductor laser element 57 is placed on the silicon substrate 58 together with the photodetection portion 56.

### SUMMARY OF THE INVENTION

An object of the present invention is to provide a semiconductor laser device which eliminates the restrictions on arrangement of wire-bonded electrodes and wiring layout and reduces the adverse effect of heat generated in the photodetector on the semiconductor laser element, and to provide an optical pickup apparatus provided with the device.

In order to achieve the object, the present invention provides a semiconductor laser device comprising:

a semiconductor laser element;

a starting mirror for reflecting laser light emitted from the semiconductor laser element toward a light-irradiated object; and

a package in which the semiconductor laser element and the starting mirror are mounted, wherein

the package is constituted by layering a plurality of ceramic sheets having mutually different conductive patterns.

According to the thus-constructed semiconductor laser device, the plurality of ceramic sheets constituting the package have mutually different conductive patterns, which allows three-dimensional wiring patterns formed of conductive patterns to be provided in the package. Therefore, it is possible to eliminate restrictions on arrangement of the electrodes formed in the package and restrictions on wiring layout of the thin metal wires which electrically connect the semiconductor laser element with the electrodes.

When a photodetector for example is mounted in the package, no placement of the semiconductor laser element above the photodetector makes it possible to reduce the adverse effect of the heat generated in the photodetector on the semiconductor laser element. This improves the high-temperature operation characteristic of the semiconductor laser element.

A hologram element, which diffracts light reflected on the light-irradiated object, may be mounted on the package. In this case, a photodetector may be further mounted in the package, the photodetector receiving the reflected light diffracted by the hologram element.

Moreover, even if the hologram element is not mounted on the package, a photodetector for receiving the light reflected on the light-irradiated object may be mounted in the package.

In one embodiment of the present invention, through-holes are respectively provided in the ceramic sheets, and the semiconductor laser element and the starting mirror are placed in the through-holes.

According to the semiconductor laser device of the embodiment, height of device is decreased since the semiconductor laser element and the starting mirror are placed in the through-holes.

In one embodiment of the present invention, through-holes are respectively provided in the ceramic sheets, and a stairs-like slope face of the through-holes is formed by accumulating the ceramic sheets having different through-holes in size respectively in such a way that a laser light reflecting surface of the starting mirror mounted on the stairs-like slope face has an angle of approximately 45 degrees with respect to a resonator length direction of the semiconductor laser element.

According to the semiconductor laser device of the embodiment, the optical axis of the laser light emitted from the semiconductor laser element can be changed by approximately 90 degrees because the laser light-reflecting surface of the starting mirror has an angle of approximately 45 degrees with respect to the resonator length direction of the semiconductor laser element.

In one embodiment of the present invention, a concave portion is provided in a side surface of the package.

According to the semiconductor laser device of the embodiment, since the concave portion is provided on the side surface of the package, when a cap for example is mounted on the package, the concave portion allows the cap to be easily mounted on the package by fitting a part of the cap to the concave portion, and a bonding force to be secured between the cap and the package.

In one embodiment of the present invention, a resonator length direction of the semiconductor laser element forms an angle of approximately 45 degrees with respect to an outer edge of the package.

According to the semiconductor laser device of the embodiment, it is possible to increase the resonator length of the semiconductor laser element without any increase in the outer edge length of the package because the resonator length direction of the semiconductor laser element forms an angle of approximately 45 degrees with respect to an outer edge of the package.

In one embodiment of the present invention, a material for the ceramic sheets is made of aluminum nitride.

According to the semiconductor laser device of the embodiment, it is possible to increase heat radiation of the package because aluminum nitride is used as a material of the ceramic sheet.

The present invention also provides an optical pickup apparatus comprising the above-stated semiconductor laser device.

According to the optical pickup apparatus of the invention, by virtue of the semiconductor laser device, the degree of freedom of design can be increased and the high-temperature operation characteristic can also be improved.

According to the semiconductor laser device of the present invention, three-dimensional wiring patterns formed of conductive patterns are provided in the package because ceramic sheets constituting the package have mutually different conductive patterns. Therefore, it is possible to eliminate the restrictions on the arrangement of the electrodes provided in the package and the restrictions on the wiring layout of the thin metal wires that electrically connect the semiconductor laser element to the electrodes.

Moreover, when a photodetector for example is mounted in the package, no placement of the semiconductor laser element above the photodetector makes it possible to reduce the adverse effect of the heat generated in the photodetector on the semiconductor laser element. Thus, the high-temperature operation characteristic of the semiconductor laser element can be improved.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic perspective view of a hologram unit that is a semiconductor laser device according to one embodiment of the present invention;

FIG. 2A is an in-process view of parts of the hologram laser unit;

FIG. 2B is an in-process view of different parts of the hologram laser unit;

FIG. 2C is an in-process view of still different parts of the hologram laser unit;

FIG. 3 is a schematic top view of a modification example of the hologram laser unit;

FIG. 4 is a schematic top view of another modification example of the hologram laser unit;

FIG. 5A is a schematic top view of a conventional semiconductor laser device;

FIG. 5B is a schematic sectional view of the conventional semiconductor laser device; and

FIG. 6 is a schematic structural view of an optical pickup apparatus provided with the semiconductor laser device according to another embodiment of the present invention.

### DETAILED DESCRIPTION OF THE INVENTION

A semiconductor laser device of the present invention and an optical pickup apparatus provided with the device is described in detail below with reference to drawings.

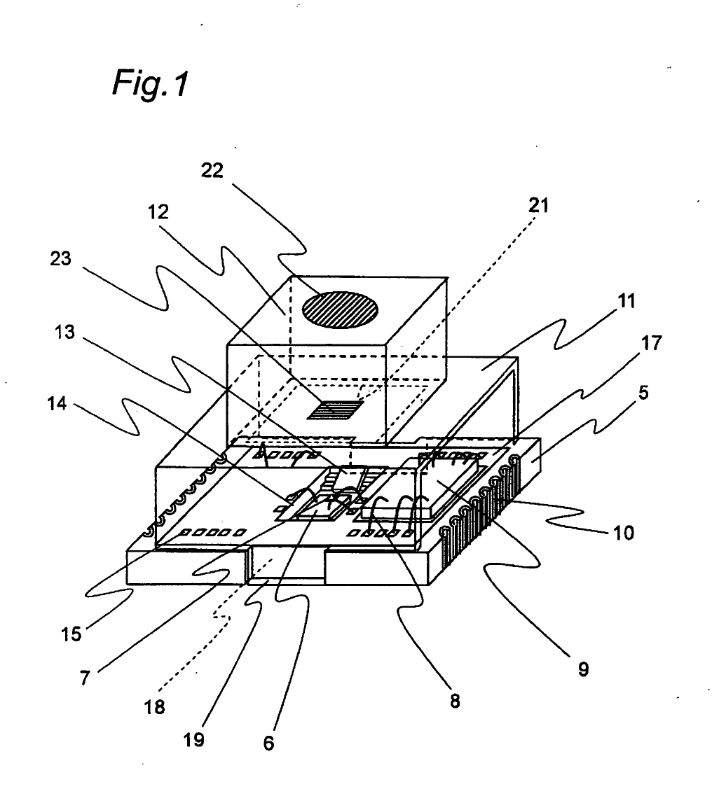

FIG. 1 shows a schematic perspective view of a hologram unit that is a semiconductor laser device according to one embodiment of the present invention. A cap 11 in FIG. 1 is shown in a transparent form so as to comprehensibly show the structure inside the hologram laser unit.

The hologram laser unit has a semiconductor laser element 7, a starting mirror 13 that reflects laser light emitted from the semiconductor laser element 7 toward an optical disk, a hologram element 12 that diffracts the light reflected on the optical disk, a signal photodetector 9 that receives the reflected light diffracted by the hologram element 12, and a laminate ceramic package 5 on the upper surface 17 of which the semiconductor laser element 7, the starting mirror 13 and the signal photodetector 9 are mounted. The optical disk is one example of a light-irradiated object. The laminate ceramic package 5 is one example of a package. The signal photodetector 9 is one example of a photodetector.

A concave portion 14 is provided in a center portion of the upper surface 17 of the laminate ceramic package 5. Moreover, a concave portion 18 and external terminals 10 are provided on side surfaces of the laminate ceramic package 5.

An opening of the concave portion 14 has a rectangular shape. The lengthwise direction of the opening of the concave portion 14 is roughly perpendicular to an edge of the laminate ceramic package 5 on the side of the concave portion 18, and roughly parallel to an edge of the laminate ceramic package 5 on the side of the external terminals 10. Then, the semiconductor laser element 7 and the starting mirror 13 are placed in the concave portion 14.

More in detail, a monitor submount 6, on which the semiconductor laser element 7 is mounted, is die-bonded to the bottom surface of the concave portion 14. The resonator length direction of the semiconductor laser element 7 is roughly perpendicular to the edge of the laminate ceramic package 5 on the side of the concave portion 18 and roughly parallel to the edge of the laminate ceramic package 5 on the side of the external terminals 10. Moreover, a side surface of the concave portion 14, which faces the laser light-emitting end surface of the semiconductor laser element 7, has a stairs-like configuration on which the starting mirror 13 is mounted.

Each of the monitor submount 6, the semiconductor laser element 7 and the signal photodetector 9 is electrically connected to at least one of electrodes 15 provided on the upper surface 17 of the laminate ceramic package 5 via a thin metal wire 8. Moreover, the monitor submount 6, the semiconductor laser element 7 and the signal photodetector 9 are covered with the cap 11 for protection. The electrode 15 is one example of a conductive pattern.

A convex portion 19 is provided in a lower portion of the cap 11b and fit to the concave portion 18 provided on a side surface of the laminate ceramic package 5. With this arrangement, the cap 11 is positioned and fixed. Moreover, an upper part of the cap 11 is provided with an opening 21 on which a hologram element 12 is placed. After optically adjusting the position of the hologram element 12 on the upper surface of the cap 11, the hologram element 12 is fixed to the upper surface of the cap 11 with a UV resin or the like.

The reflecting surface 20 of the starting mirror 13 reflects the laser light emitted from the laser light-emitting end surface of the semiconductor laser element 7. The reflecting surface 20 is oriented at an angle of approximately 45 degrees with respect to the resonator length direction of the semiconductor laser element 7. With this arrangement, the laser light reflected on the reflecting surface 20 travels toward a direction roughly perpendicular to the upper surface 17 of the laminate ceramic package 5. That is, the starting mirror 13 changes the optical axis of the laser light emitted from the laser light-emitting end surface of the semiconductor laser element 7 at an angle of approximately 90 degrees.

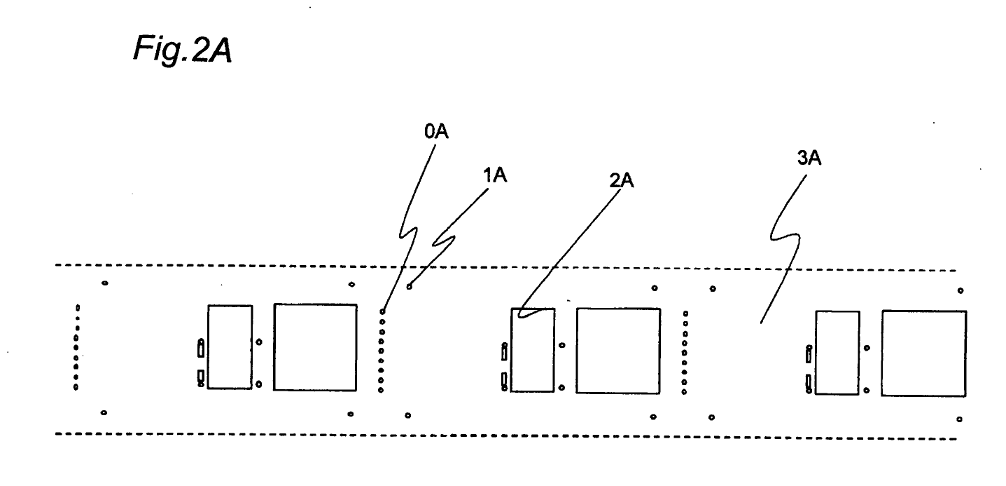

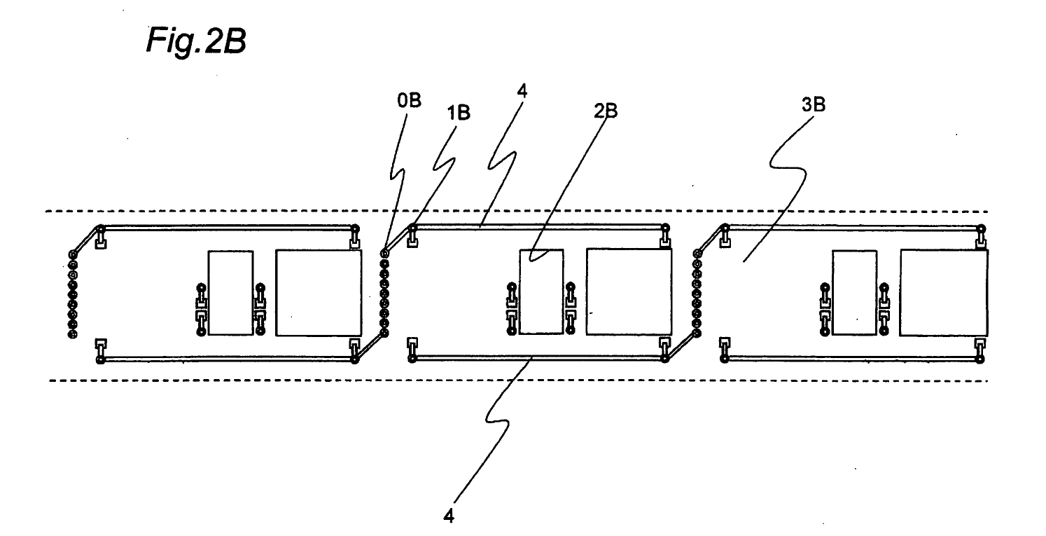

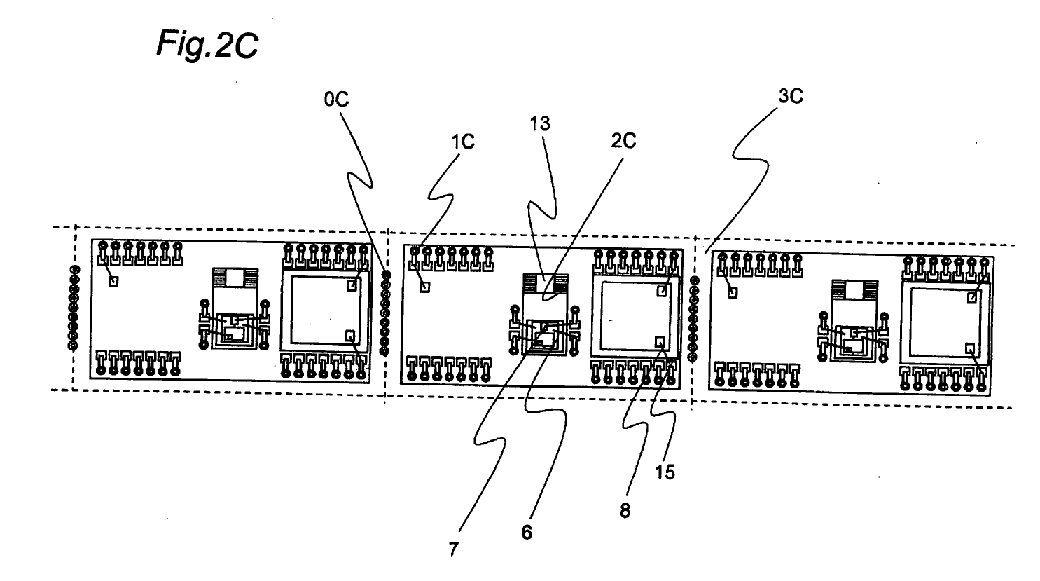

The electrodes 15 are electrically connected to the external terminals 10 (see FIG. 2B) via a conductive pattern 4 that is three-dimensionally formed in the laminate ceramic package 5.

A diffraction grating 22 is provided on the upper surface of the hologram element 12, the opposite surface of which is located on the side of the semiconductor laser element 7. A diffraction grating 23 having a different configuration from that of the diffraction grating 22 is provided on the lower surface of the hologram element 12, that is, the surface thereof located on the side of the semiconductor laser element 7.

The manufacturing method of the hologram laser unit is described below with reference to FIGS. 2A through 2C.

First, as shown in FIG. 2A, viaholes 0A, 1A and a punching hole 2A as an example of a through-hole are provided in a thin ceramic sheet 3A. Each of the viaholes is also a through-hole and has a conductive pattern on an inner surface thereof so as to electrically connect viaholes of ceramic sheets located above and blow the ceramic sheet.

As shown in FIG. 2B, viaholes 0B, 1B and a punching hole 2B, which are through-holes, are provided in a thin ceramic sheet 3B. Then, a conductive pattern 4 is pattern-printed on the upper surface of the ceramic sheet 3B with a conductive paste (e.g., Ag paste). The punching hole 2B is larger than the punching hole 2A. The conductive pattern 4 is electrically connected to the conductive pattern of the inner surface of the viahole 0B and the conductive pattern of the inner surface of the viahole 1B.

As shown in FIG. 2C, viaholes 0C, 1C, a punching hole 2C larger than the punching hole 2A and electrodes 15 are provided in a thin ceramic sheet 3C. The punching hole 2C is a through-hole.

The ceramic sheets 3A to 3C are baked together with a ceramic sheet having no punching holes. Thereby, a plate member is obtained which includes a plurality of laminate ceramic packages 5 each provided with a three-dimensional circuit pattern.

Next, the monitor submount 6, the semiconductor laser element 7 and the signal photodetector 9 are mounted on prescribed positions of each of the laminate ceramic package 5.

Next, the monitor submount 6, the semiconductor laser element 7 and the signal photodetector 9 are electrically connected to the electrodes 15 via the thin metal wires 8. Thereafter, the plate member is cut along the dashed lines (dashed lines intersecting the center of the viaholes 0C) shown in FIG. 2C, so as to form the external terminals 10 (obtained by dividing the viaholes 0A, 0B and 0C into halves) and the concave portion 18 on the side surfaces of the laminate ceramic package 5. Thereby, the separated laminate ceramic packages 5 are obtained, on each of which the monitor submount 6, the semiconductor laser element 7 and the signal photodetector 9 are mounted. Moreover, the electrodes 15 are electrically connected to the external terminals 10 via the conductive pattern 4 (see FIG. 2B) or the like.

Finally, the cap 11 is mounted on the laminate ceramic package 5, and thereafter the hologram element 12 is secure to the upper surface of the cap 11 with a UV resin or the like. Thereby, the complete hologram laser unit shown in FIG. 1 is obtained.

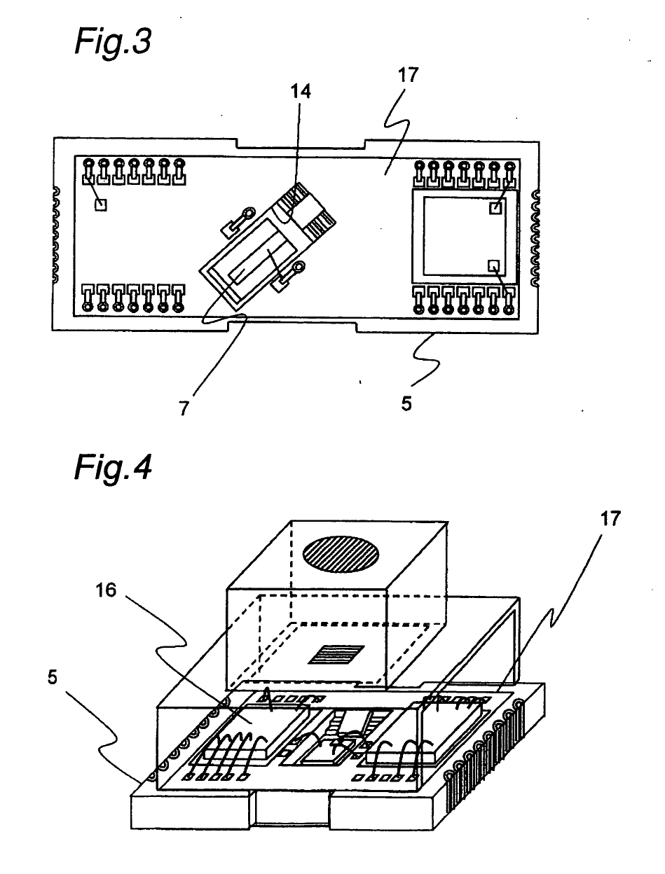

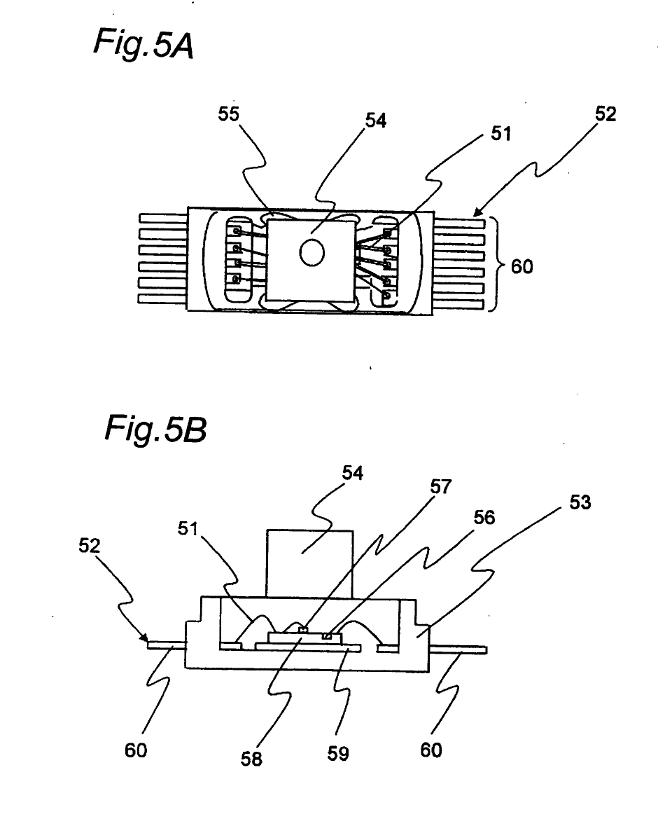

In the above-stated embodiment, the lengthwise direction of the opening of the concave portion 14 is perpendicular to the edge of the laminate ceramic package 5 located on the side of the concave portion 18. However, it is acceptable to angle the lengthwise direction of the opening of the concave portion 14 at an angle of approximately 45 degrees to the edge of the laminate ceramic package 5 located on the side of the concave portion 18, as shown in FIG. 3. With this arrangement, a semiconductor laser element 7 having a longer resonator length can be placed in the concave portion 14 without any increase in length of the edge of the laminate ceramic package 5 located on the side of the external terminals 10, which is achieved by only increasing the length in the lengthwise direction of the concave portion 14.

It is also acceptable to mount a semiconductor laser element driving IC (integrated circuit) 16 on the upper surface 17 of the laminate ceramic package 5 as shown in FIG. 4. Thereby, the hologram laser unit is further integrated, which makes it possible to reduce size and thickness of the optical pickup apparatus.

Although not shown in the drawings, it is acceptable to mount a high-frequency overlay IC on the upper surface 17 of the laminate ceramic package 5 in the case where a semiconductor laser element of a single oscillation mode necessary for high-frequency overlay is mounted on the upper surface 17 of the laminate ceramic package 5.

Moreover, AlN (aluminum nitride) may be used as a material of the laminate ceramic package 5 since thermal conductivity of AlN is greater than that of silicon. Specifically, the laminate ceramic package 5 may be constructed of ceramic sheets of AlN. This construction allows heat of the hologram laser unit to be more effectively released in comparison with a silicon package where which the semiconductor laser element 7, the signal photodetector 9 and so on are mounted.

As described above, the hologram laser unit may be mounted on an optical pickup apparatus.

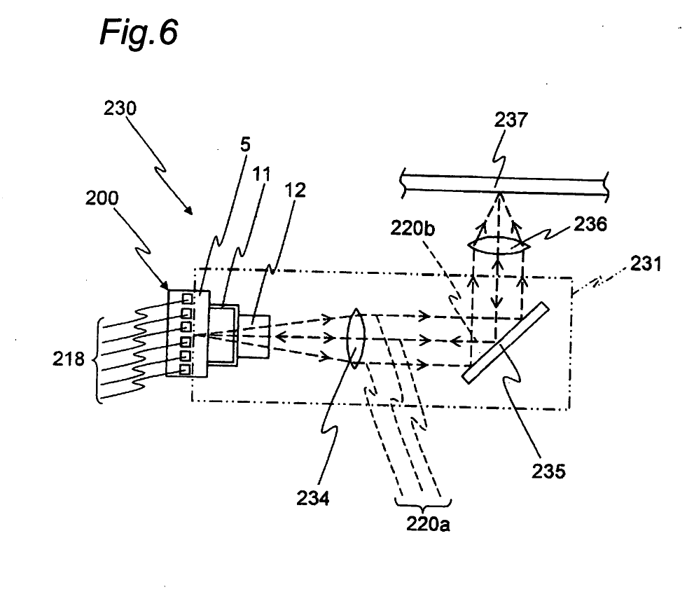

FIG. 6 shows a schematic structural view of an optical pickup apparatus 230 provided with a semiconductor laser device 200 according to another embodiment of the present invention.

The optical pickup apparatus 230 has an optical pickup apparatus casing 231, a collimating lens 234, a starting mirror 235 and an object lens 236 besides a semiconductor laser device 200.

In the semiconductor laser device 200, the external terminals 10, which are formed by dividing the viaholes 0C into halves, are exposed on both sides of the laminate ceramic package 205 to serve as electrodes 218. Same components in FIG. 6 as the components of the semiconductor laser device shown in FIG. 1 are denoted by the same reference numerals as those of the components shown in FIG. 1. Description therefor is omitted.

The collimating lens 234 transforms incident light into parallel light. Specifically, laser light emitted from the semiconductor laser element 7 (see FIG. 1) of the semiconductor laser device 200 is transformed into parallel light 220a by the collimating lens 234.

The starting mirror 235 bends the optical path of the laser light 220a, which has passed through the collimating lens 234, at an angle of 90 degrees. As a result, the laser light 220a is conducted to the object lens 236.

The object lens 236 condenses the laser light 220a, which is bent by the starting mirror 235, onto the surface of an optical recording medium 237 located on the side of the starting mirror 235.

The optical pickup apparatus casing (hereinafter referred to as a “casing”) 231 is formed by metal casting or die casting. The collimating lens 234 and the starting mirror 235 are adjusted so that the center of the mounting hole (not shown) of the housing 231 and the optical axis of the semiconductor laser device 200 can accurately coincide with each other, and thereafter fixed to the housing 231.

The optical pickup apparatus 230 is assembled by inserting the semiconductor laser device 200 into the mounting portion (not shown) of the housing 231. At this time, the optical axis of the semiconductor laser device 200 parallel to the direction of emission of the laser light 220a is adjusted by bringing a surface of the laminate ceramic package 5, which surface is located on the side of the hologram element 12, in contact with the surface formed at the mounting portion of the housing 231.

As shown in FIG. 6, the laser light 220a emitted from the semiconductor laser device 200 is transformed into parallel light by the collimating lens 234, bent at an angle of 90 degrees by the starting mirror 235, and condensed on the surface of the optical recording medium 237 located on the side of the starting mirror 235 by the object lens 236. The optical pickup apparatus 230 employs a starting mirror 235 having a sufficiently large area, on which the laser light 220a is incident, so as to reflect the whole laser light 220a transmitted through the collimating lens 234. Specifically, sides of a starting mirror 235 need to be 7 mm or more in length because the effective diameter of the collimating lens 234 is about 5 mm.

The laser light reflected on the optical recording medium 237 becomes signal light 220b containing the information recorded in the optical recording medium 237. The signal light 220b passes through a path opposite to that from the semiconductor laser device 200 to the optical recording medium 237, specifically, in order of the object lens 236, the starting mirror 235 and the collimating lens 234, and returns to the semiconductor laser device 200. The signal light 220b that returns to the semiconductor laser device 200 is diffracted by the hologram pattern (not shown) formed at the hologram element 12, and received by the photodetector 9 (see FIG. 1). The signal from the photodetector 9 allows obtaining the information recorded in the optical recording medium 237. Control signals such as a focus error signal and a tracking error signal are also obtained by the photodetector 9.

The hologram pattern is divided into a plurality of regions in order to generate the information to be recorded in the optical recording medium 237 and the control signals such as the focus error signal and the tracking error signal.

It is acceptable to provide a plurality of the hologram patterns. Also, the hologram patterns may diffract different wavelengths from each other. In this case, it is only necessary to separate the light at every wavelength in advance.

As described above, the optical pickup apparatus 230 shown in FIG. 6 has the construction in which the hologram element 12 is integrated with the laminate ceramic package 5. However, the hologram element 12 does not necessarily need integration with the laminate ceramic package 5. Also, the cap is not necessarily required.

The invention being thus described, it will be obvious that the invention may be varied in many ways. Such variations are not be regarded as a departure from the spirit and scope of the invention, and all such modifications as would be obvious to one skilled in the art are intended to be included within the scope of the following claims.

1. A semiconductor laser device comprising:
a semiconductor laser element;
a starting mirror for reflecting laser light emitted from the semiconductor laser element toward a light-irradiated object; and
a package in which the semiconductor laser element and the starting mirror are mounted, wherein
the package is constituted by layering a plurality of ceramic sheets having mutually different conductive patterns.

2. The semiconductor laser device as claimed in claim 1, wherein
through-holes are respectively provided in the ceramic sheets, and
the semiconductor laser element and the starting mirror are placed in the through-holes.

3. The semiconductor laser device as claimed in claim 1, wherein
through-holes are respectively provided in the ceramic sheets
a stairs-like slope face of the through-holes is formed by accumulating the ceramic sheets having different through-holes in size respectively in such a way that a laser light reflecting surface of the starting mirror mounted on the stairs-like slope face has an angle of approximately 45 degrees with respect to a resonator length direction of the semiconductor laser element.

4. The semiconductor laser device as claimed in claim 1, wherein
a concave portion is provided in a side surface of the package.

5. The semiconductor laser device as claimed in claim 1, wherein
a resonator length direction of the semiconductor laser element forms an angle of approximately 45 degrees with respect to an outer edge of the package.

6. The semiconductor laser device as claimed in claim 1, wherein
a material for the ceramic sheets is made of aluminum nitride.

7. An optical pickup apparatus comprising the semiconductor laser device claimed in claim 1.
